(19) United States
(12) Patent Application Publication
(10) Pub. No.: US 2026/0141243 A1
(43) Pub. Date: May 21, 2026

(54) COMMUNICATION-EFFICIENT TRAINING FOR WIRELESS SPLIT-LEARNING-BASED FUNCTIONS

(71) Applicant: Huawei Technologies Co., Ltd., Shenzhen (CN)

(72) Inventors: Omar Ahmad Mohammad Alhussein, Ottawa (CA); Mehdi Arashmid Akhavain Mohammadi, Ottawa (CA)

(21) Appl. No.: 19/431,798

(22) Filed: Dec. 23, 2025

Related U.S. Application Data
(63) Continuation of application No. PCT/CN2023/104056, filed on Jun. 29, 2023.

(51) Int. Cl. G06N 3/084; H04L 41/0826; H04L 41/16

(52) U.S. Cl. CPC G06N 3/084; H04L 41/0826; H04L 41/16

(57) ABSTRACT

Methods, apparatus, and systems for training a neural network that is split over elements of a communication network are disclosed. To train a split neural network, data needs to be iteratively transmitted between encoding and decoding parts of the neural network, which requires provisioning of resources from the communication network. Embodiments of the present disclosure involve determining whether to send model parameters between the encoding and decoding parts. Some embodiments may determine this based on the size of the neural network and the size of the dataset needed for training. Some embodiments may send the modelling parameters to a location intermediate between the encoding and decoding parts for processing.

### CROSS-REFERENCE TO RELATED APPLICATION

This application is a continuation of PCT Application No. PCT/CN2023/104056, filed on Jun. 29, 2023, which application is hereby incorporated herein by reference in its entirety.

### TECHNICAL FIELD

The present disclosure generally relates to communication networks, and more particularly methods, apparatus, and systems for optimizing the use of resources in communication networks.

### BACKGROUND

Split learning is a distributed learning technique in which a neural network is separated, or split, into multiple parts to preserve privacy, reduce communication overhead and reduce energy overhead for clients. The partitioning of the neural network can be achieved through logical or physical separation. For example, one part could be retained in a client device while another could be placed at a server device. Typically, a first part of the neural network processes input data to extract features that model the input data in a compressed form of code known as a latent representation. The latent representation is then sent to a second part of the neural network where it is processed to produce a prediction or a classification. Altogether, the processing and transmission of the latent representation make up a forward pass, or forward propagation, for the split neural network. To train the neural network, back propagation is also typically performed, wherein gradients of the error between predicted and true results are sent back through the neural network to refine the neural network layers that are used to process input data and the latent representation. Because much of the processing is done away from the client, this typical approach to split learning can reduce the processing costs to the client, and because the latent representation is sent in lieu of raw input data, the approach can keep the client private from the server and may reduce communication costs.

Despite the above benefits, sending the latent representation and error gradients back and forth over numerous cycles to progressively train a neural network can still be resource intensive for communications networks. Typical split learning approaches are particularly inefficient in wireless access domains, where bottlenecks usually arise from a limited availability of transmission resources. Furthermore, protecting privacy is not always relevant and can impose unnecessary constraints on processes within the neural network. This can be the case in telecommunications applications, for example, in functions for optimizing network operations, where both parts of a split neural network may be controlled by the telecommunications provider. With these constraints, the current approaches to split learning limit the technique's communication efficiency.

Therefore, improvements in the communication efficiency of split learning are desirable.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide improvements in the communication efficiency of split learning.

A first aspect of the present disclosure is to provide a method for training a neural network that has one or more encoders and a decoder. The one or more encoders can make up an encoder series, with each encoder having respective encoder model parameters and being deployed in a respective encoder network element of one or more encoder network elements. The decoder can be deployed in a decoder network element. Each encoder network element can be coupled to the decoder network element across a first separation and to a respective proxy location of one or more proxy locations. Each proxy location can be coupled to the decoder network element over a respective second separation, with each second separation being shorter than the respective first separation. The method comprises determining a communication cost parameter (CCP) for training the neural network, and when the CCP is greater than a threshold value, performing a set of actions for each encoder of the encoder series. The set of actions comprises sending, by the respective encoder network element, the respective encoder model parameters to the respective proxy location.

In some embodiments of the first aspect, the set of actions is performed for each encoder of the encoder series when the CCP is equal to the threshold value. In some embodiments, the set of actions is repeated one or more times for each encoder of the encoder series when the CCP is greater than the threshold value or when the CCP is equal to the threshold value.

In some embodiments of the first aspect, each encoder is configured to process respective input data having respective true labels, the decoder has decoder model parameters, and the set of actions further comprises: forward propagating, by the respective encoder and in accordance with the respective encoder model parameters, respective input data to obtain respective latent codes; sending, by the respective encoder network element, the respective latent codes to the decoder; and forward propagating, by the decoder and in accordance with the decoder model parameters, the respective latent codes to obtain respective prediction labels. In some embodiments, the set of actions further comprises: determining respective errors between the respective prediction labels and respective true labels; back propagating the respective errors to obtain respective gradients of the respective errors with respect to the decoder model parameters; back propagating the respective gradients of the respective errors with respect to the decoder model parameters to update the decoder model parameters; back propagating the respective gradients of the respective errors with respect to the decoder model parameters to obtain respective gradients of the respective errors with respect to the respective latent codes; sending, by the decoder network location, the respective gradients of the respective errors with respect to the respective latent codes to the respective proxy location; back propagating, at the respective proxy location, the respective gradients of the respective errors with respect to the respective latent codes to update the respective encoder model parameters; sending, by the respective proxy location, the respective encoder model parameters to a next encoder network element, the next encoder network element being one of the one or more encoder network elements and defined by the encoder series; and updating, at the next encoder network element, next encoder model parameters, the next encoder model parameters being encoder model parameters corresponding to a next encoder, the next encoder being one of the one or more encoders and corresponding to the next encoder network element. In some embodiments, back propagating, at the respective proxy location, the respective gradients of the respective errors with respect to the respective latent codes to update the respective encoder model parameters includes calculating respective gradients of the respective errors with respect to the respective encoder model parameters.

In some embodiments of the first aspect, each encoder is configured to process respective input data having respective true labels, the decoder has decoder model parameters, and the method further comprises performing a second set of actions when the CCP is less than a threshold value. The second set of actions comprises: forward propagating, by each encoder and in accordance with the respective encoder model parameters, respective input data to obtain respective latent codes; sending, by each encoder network element, the respective latent codes to the decoder; concatenating the latent codes to obtain an aggregate latent code; forward propagating, by the decoder and in accordance with the decoder model parameters, the aggregate latent code to obtain a set of prediction labels; determining a set of errors between the set of prediction labels and a set of true labels, the set of true labels comprising the true labels of the input data of each encoder; back propagating the set of errors to obtain a set of gradients of the set of errors with respect to the decoder model parameters; back propagating the set of gradients of the set of errors with respect to the decoder model parameters to update the decoder model parameters; back propagating the set of gradients of the respective errors with respect to the decoder model parameters to obtain a set of gradients of the respective errors with respect to the aggregate latent code; sending, by the decoder network element, the set of gradients of the errors with respect to the aggregate latent code to each encoder network element of the one or more encoder network elements; and back propagating, at each encoder network element, the set of gradients of the set of errors with respect to the aggregate latent code to update the respective encoder model parameters of the respective encoder. In some embodiments, back propagating, at each encoder network element, the set of gradients of the set of errors with respect to the aggregate latent code to update the encoder model parameters of the respective encoder includes calculating a respective set of gradients of the set of errors with respect to the respective encoder model parameters. In some embodiments, the second set of actions is performed when the CCP is equal to the threshold value. In some embodiments, the second set of action is repeated one or more times, when the CCP is less than the threshold value or when the CCP is equal to the threshold value.

In some embodiments of the first aspect, the CCP is defined by a ratio of a first communication cost to a second communication cost. In some embodiments, the first communication cost depends from a product comprising a size of an input dataset and a size of one latent code. In some embodiments, the first communication cost is defined by a product comprising a size of an input dataset, a size of one latent code, and a sum comprising 1 and a count of the one or more encoders. In some embodiments, the input dataset comprises the input data of each encoder. In some embodiments, the second communication cost depends from a size of the encoder model parameters of one encoder. In some embodiments, the second communication cost is defined by a sum comprising: a product comprising 2, a count of the one or more encoders, and a size of the encoder model parameters of one encoder; and a product comprising a size of an input dataset and a size of one latent code.

In some embodiments of the first aspect, the threshold value is unity.

In some embodiments of the first aspect, one or more of the one or more proxy locations belongs to the decoder network element. In some embodiments, one or more of the one or more proxy locations is a digital twin for the respective network element.

In some embodiments of the first aspect, the one or more encoder network elements and the decoder network element belong to a communication network. In some embodiments, the communication network is a mobile network or a wireless access network. In some embodiments, the decoder network element is a base station or a commodity server. In some embodiments, one or more of the one or more encoder network elements are each a user equipment or an internet-of-things device.

A second aspect of the present disclosure provides a communication network comprising one or more encoder network elements, one or more proxy locations, and a decoder network element. Each encoder network element has a neural network encoder, each of which has encoder model parameters and is configured to generate one or more latent codes from input data in accordance with the respective encoder model parameters. Each encoder network element is configured to obtain input data, transmit latent codes, and transmit encoder model parameters when a CCP is greater than a threshold value. Each proxy location is coupled to one or more encoder network elements and is configured to receive encoder model parameters from the respective one or more encoder network elements. The decoder network element has a neural network decoder and is coupled to each encoder network element and each proxy location. The decoder has decoder model parameters and is configured to generate one or more prediction labels from latent codes in accordance with the decoder model parameters. The second network element is configured to receive latent codes from each encoder network element.

In some embodiments of the second aspect, the decoder network element is further configured to obtain true labels corresponding to the input data of each encoder network element; determine an error between each prediction label and the respective true label; back propagate each error to obtain a gradient of the respective error with respect to the decoder model parameters; back propagate each gradient of an error with respect to the decoder model parameters to update the decoder model parameters; back propagate each gradient of an error with respect to the decoder model parameters to obtain a respective gradient of the error with respect to a respective latent code; and transmit each gradient of an error with respect to a respective latent code. In some embodiments, each proxy location is further configured to: receive gradients of errors with respect to respective latent codes from the decoder network element; back propagate each gradient of an error with respect to a respective latent code to obtain a respective gradient of the error with respect to respective encoder model parameters; back propagate each gradient of an error with respect to respective encoder model parameters to update the respective encoder model parameters; and transmit encoder model parameters. In some embodiments, each encoder network element is further configured to receive encoder model parameters from the respective proxy location.

In some embodiments of the second aspect, each encoder network element is further configured to: receive gradients of errors with respect to respective latent codes from the decoder network element; back propagate each gradient of an error with respect to a respective latent code to obtain a respective gradient of the error with respect to respective encoder model parameters; and back propagate each gradient of an error with respect to respective encoder model parameters to update the respective encoder model parameters.

In some embodiments of the second aspect, each encoder network element is further configured to transmit encoder model parameters when the CCP is equal to the threshold value.

In some embodiments of the second aspect, the CCP is defined according to any of the variations of the first aspect.

In some embodiments of the second aspect, each encoder network element is coupled to the decoder network element over a respective first separation, each proxy location is coupled to the decoder network element over a respective second separation, and each second separation is shorter than the respective first separation.

In some embodiments of the second aspect, one or more of the one or more proxy locations is located at the decoder network element.

A third aspect of the present disclosure provides an electronic device comprising a processor coupled to tangible, non-transitory processor-readable memory, with the memory having stored thereon instructions to be executed by the processor to implement the method of the first aspect. Some embodiments of the third aspect may further provide the embodied variations of the first aspect. The electronic device may be an apparatus, a component or a module in a device.

A fourth aspect of the present disclosure provides a non-transitory processor-readable memory having stored thereon instructions to be executed by the processor to implement the method of the first aspect.

A fifth aspect of the present disclosure provides a computer program comprising instructions to be executed by a computer to implement the method of the first aspect.

A sixth aspect of the present disclosure provides a system comprising the electronic device of the third aspect.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1A shows a typical neural network in the form of an encoder-decoder network, where embodiments of the present disclosure may be implemented.

FIG. 1B shows a typical split neural network, where embodiments of the present disclosure may be implemented.

FIG. 2 shows a typical split learning scenario, where embodiments of the present disclosure may be implemented.

FIG. 3A shows a neural network, according to a configuration typical of the prior art.

FIG. 3B shows a forward propagation for a split neural network, according to a method typical of the prior art.

FIG. 3C shows a back propagation for a split neural network, according to a method typical of the prior art.

FIG. 4 shows split learning in a wireless access system, according to an embodiment of the present disclosure.

FIG. 5A shows a flowchart of a method for split learning with the encoder model being sent over the edge, according to an embodiment of the present disclosure.

FIG. 5B shows a flowchart of a method for split learning without the encoder model being sent over the edge, according to an embodiment of the present disclosure.

FIG. 6 shows an apparatus for split learning, according to embodiments of the present disclosure.

FIG. 7 shows a schematic of an embodiment of a neural network processor chip that may implement at least part of the methods and features of the present disclosure.

FIG. 8 shows a schematic of an embodiment of an electronic device that may implement at least part of the methods and features of the present disclosure.

### DETAILED DESCRIPTION OF THE ILLUSTRATIVE EMBODIMENTS

To improve the communication efficiency of split learning, embodiments of the present disclosure are generally directed towards using conditional logic to determine whether to send out the model parameters of a first part of a split neural network that has two parts connected by a communication network. Some embodiments may send the model parameters to a proxy location that is closer to the second part of the split neural network to reduce the burdens imposed on the communication network from training the neural network. These burdens, or communication costs, may encompass a provisioning of network resources for a transmission duration to facilitate the transmission of data between the two parts of the split neural network. In some further embodiments, the conditional logic for determining whether to send the model parameters may be based on the communication costs associated with sending or not sending the model parameters.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be used interchangeably throughout the disclosure: “forward pass” and “forward propagation”; “latent representation” and “latent code”; “true label” and “true value”; “model parameters” and “weights and biases”; “secure location”, “digital twin”, and “proxy location”; “sending” and “transmitting”; and “prediction”, “prediction label”, and “obtained label”.

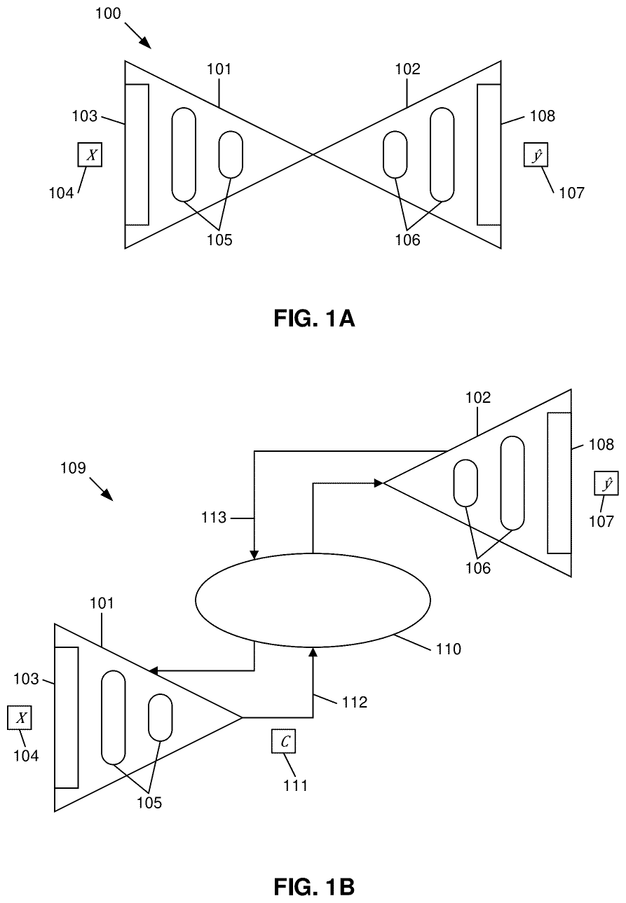

FIG. 1A shows a typical neural network (NN) 100 with an encoder 101 part and decoder 102 part. The encoder 101 includes an input layer 103 that is configured to receive input data 104, X. The encoder 101 also includes one or more encoder layers 105, while the decoder 102 includes one or more decoder layers 106. Together, the encoder layers 105 and decoder layers 106 process the input data 104 to produce a prediction 107, ŷ, at an output layer 108 of the decoder 102. Processing at each layer of the NN may be described by a mathematical expression that applies a transformation to the input data according to particular parameters of the expression (“model parameters” or “weights and biases”).

In split learning, the encoder and decoder parts of a NN are separated from one another, either by a logical or physical separation. FIG. 1B shows a typical split NN 109. Here, the encoder 101 with an input layer 103 and encoder layers 105 is separated from, yet still connected to, the decoder 102 with output layer 108 and decoder layers 106. The encoder 101 and decoder 102 remain connected through a network 110. The network 110 may comprise any number of connections and nodes, and may include physical links (e.g., ethernet or optical cables) and/or wireless links (e.g., radiowave or microwave). For the split NN 109 to produce a prediction 107, the encoder 101 may first produce a latent representation (or “latent code”) 111, C, from input data 104, using the encoder layers 105. The latent representation may be a compressed form of code having particular features extracted from the input data 104. The latent representation may then be sent (or “transmitted”) through the network 110 to the decoder 102 for further processing, using the decoder layers 106, to produce a prediction 107. The combined process of producing the latent representation from the input data 104 and of producing the prediction 107 from the latent representation may be known as a forward propagation 112 (or “forward pass”). Each action in the combined process may be said to be forward propagating. To train the split NN 109, a process of back propagation 113 may be performed. In back propagation, the error between the prediction 107 (or “prediction label”) and a known true value (or “true label”) may be calculated along with the gradients of the error with respect to model parameters of the decoder layers 106, the latent representation, and the encoder layers 105. These gradients may be used to update or tune the NN model parameters. Each action in the process of back propagation 113 may be said to be back propagating. Iterating forward propagations 112 with subsequent back propagations 113 may improve the accuracy of the split NN 109 and may be performed until one or more convergence criteria are achieved.

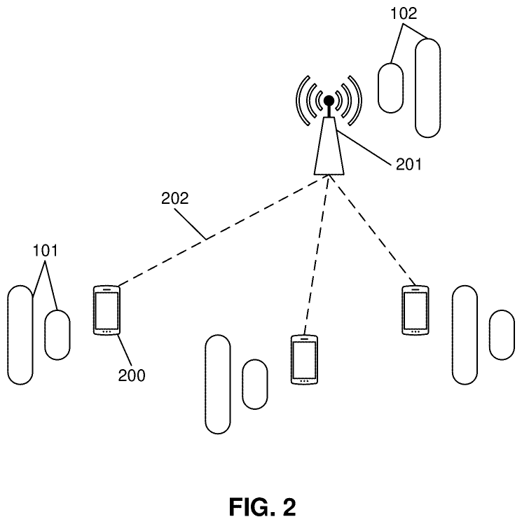

In situations that may be modelled by NNs with few layers or parameters, such as in common wireless access problems or in the wireless domain, the split learning approach of FIG. 1B may not be the most communication-efficient approach. In such situations, the communication resources that are available for transmitting information between the encoder and decoder may limit the training efficiency of the NN. FIG. 2 shows an example of a communication network according to such a situation. Here, one or more user equipment (UE) 200, which may, for example, be mobile devices or mobile phones, may have the encoder 101 part of a split NN 109, and the decoder 102 part may be located in a network base station 201, or in any other location within the network that is beyond the UEs 200, i.e., that is across the “network edge”. The network edge may define the boundary between UEs 200 and the rest of the network, and may, for example, comprise entry points for UEs 200 to the core network. Each UE 200 may be connected to the base station 201 via a wireless channel 202.

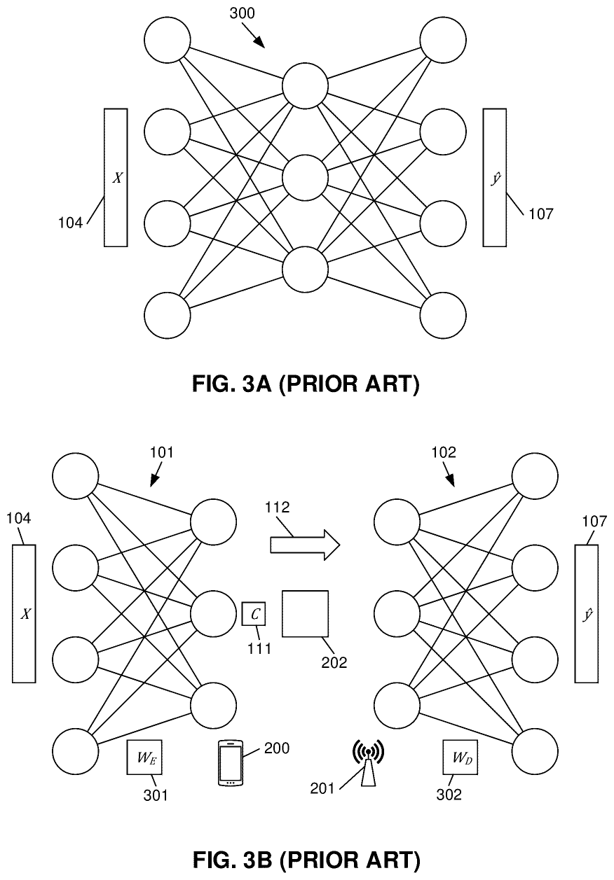

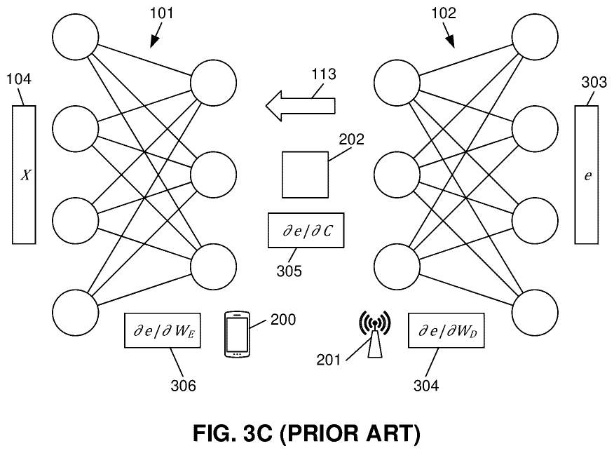

FIG. 3A shows a typical, prior art, NN 300 that may be applied in the situation of FIG. 2 for each UE and is configured to receive input data 104 and produce predictions 107. The input data 104 may be received from a dataset, D:{X, y}, comprising samples of input data 104, each corresponding to a true label, y. Each sample may have a number of features. The size of the dataset is |D|, which is equal to the number of samples in the dataset. When split, as shown in FIG. 3B and FIG. 3C, the NN 300 may have its encoder 101 located at UE 200 and its decoder 102 located at base station 201. The encoder 101 may have encoder weights and biases (EWB) 301, W_{E}, and the decoder may have decoder weights and biases (DWB) 302, W_{D}. FIG. 3B shows, according to the prior art, an example forward propagation 112, where a latent representation may be generated for each sample of the input data 104 at the encoder 101 using the EWB 301; each latent representation 111 may be sent across the wireless channel 202 to the decoder 102; and a prediction 107 may be generated from each latent representation 111 using the DWB 302. The communication cost for the forward propagation 112 may then be the cost of sending each latent representation 111 for every sample of the dataset, the communication cost for the forward propagation being expressed as the product |D∥C|, where |C| is the size of a latent representation 111. FIG. 3C shows, according to the prior art, an example back propagation 113, where errors 303, e, between the true labels and the predictions 107 are calculated at the base station 201; gradients of the errors with respect to the DWB 304, ∂e/∂W_{D}, are calculated at the base station 201 and the DWB 302 (shown at FIG. 3B) are updated accordingly; gradients of the errors with respect to the latent representations 305, ∂e/∂C, are calculated at the base station 201 and are sent across the wireless channel 202 to the UE 200; and gradients of the errors with respect to the EWB 306, ∂e/∂W_{E}, are calculated at the UE 200 and the EWB 301 (shown at FIG. 3B) are updated accordingly. The communication cost for the back propagation 113 may then be the cost of sending the gradient of the error with respect to the latent representation 305 for every sample of the dataset, the communication cost for the back propagation 113 being expressed as the product |D∥∂e/∂C|, where |∂e/∂C| is the size a gradient of the error with respect to a latent representation 305. The size of the gradient is equivalent to the size of the latent representation; therefore, |D∥∂e/∂C|=|D∥C|.

When training a NN, the aim is to have the NN model learn the functional mapping between the input data and the true labels, so that the NN can produce accurate predictions or classifications from input data lacking true labels. To improve the accuracy of these predictions or classifications, the weights of the model may be refined iteratively over multiple forward propagation and back propagation cycles, with each cycle (one forward propagation plus one back propagation) constituting a “training epoch”. For the split learning examples shown at FIG. 3B and FIG. 3C, the communication cost for each training epoch is 2|D∥C|. This communication cost, depending only on the size of the dataset and the size of the latent code, is not affected by the size of the NN.

Embodiments of the present disclosure may reduce the communication costs for the training of split NNs.

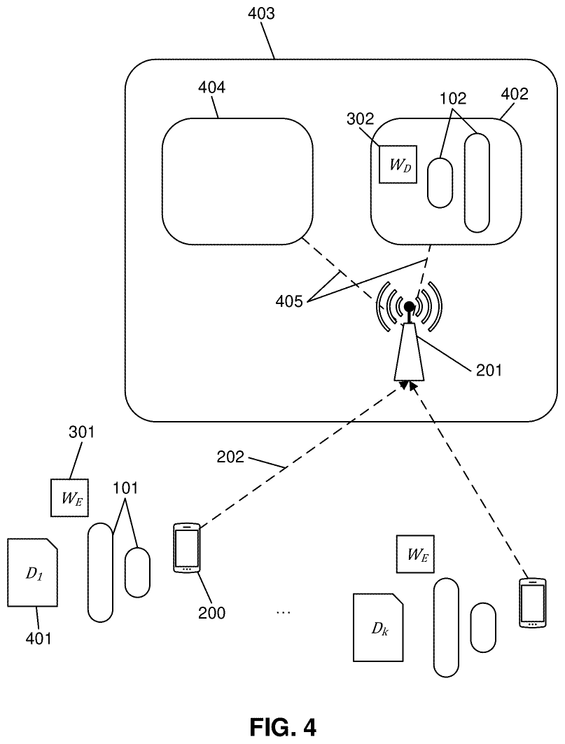

FIG. 4 shows a non-limiting example of a wireless access system for a network according to an embodiment of the present disclosure. The system may be used by K users (K is a positive integer) each having associated thereto a respective one of K UEs 200. Each UE 200 may have a replica of an encoder 101 (an encoder series) with EWB 301 and may have a dataset 401, Dₖ, where k is an index of the UE over the K UEs 200. In this example, each UE 200 has collected data with the same features as the other UEs 200 to form its respective dataset 401. The overall dataset, D, is an aggregation of all K datasets, i.e., D={D₁, . . . , Dₖ, . . . , D_{K}}. The system may also include a server 402 that has a decoder 102 with DWB 302. The server 402 may be located in a base station 201 or a commodity server at the edge 403 of the network. The system may further include one or more secure locations (or “proxy locations”) 404 in the edge 403 for each UE 200. The one or more “proxy locations” 404 associated to a particular UE 200 can host the processes of the particular UE 200. These secure, proxy locations 404 for each UE 200 may be known as “digital twins” (DTs). Each UE 200 may be connected to the base station 201, server 402, and DT 404 through a respective wireless channel 202, and the base station 201 may be connected to the server and respective DT 404 through respective fronthaul channels 405, which may be wired or wireless.

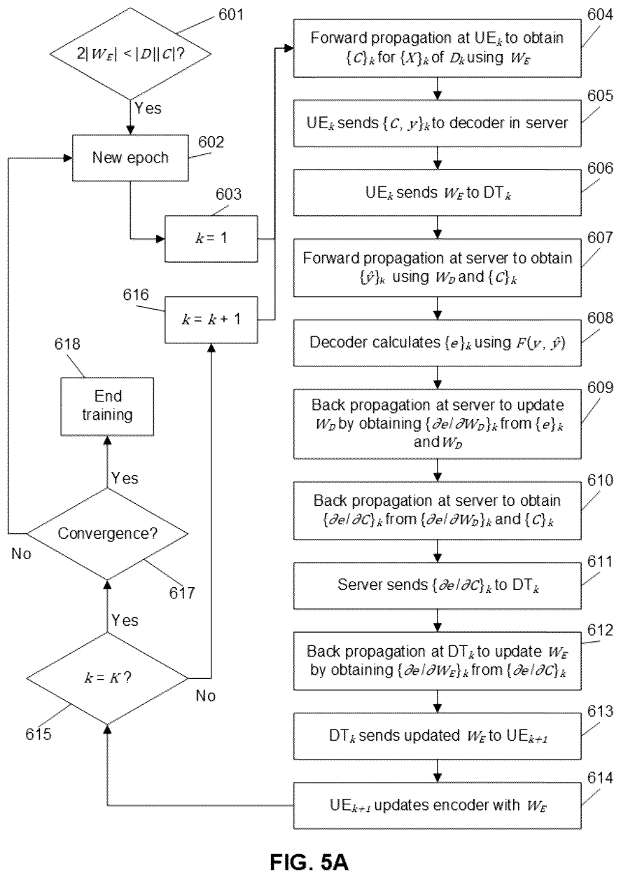

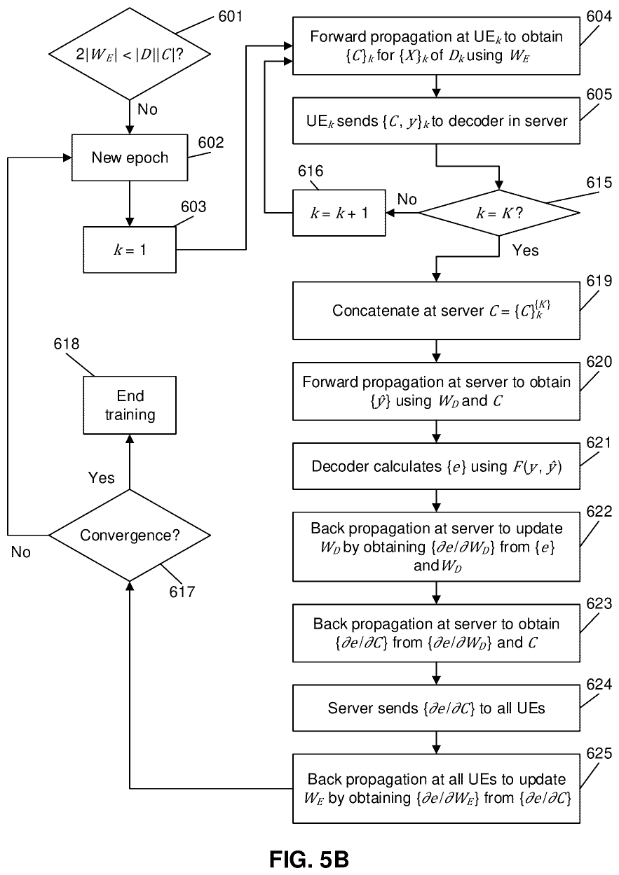

The split NN (encoder 101 split from the decoder 102) shown in FIG. 4 may be trained according to methods of the present disclosure, as shown, for example, by the flowcharts of FIG. 5A and FIG. 5B, each of which shows a respective embodiment of a method in accordance with the present disclosure. The training protocols may be invoked when the NN models need updating or according to an update frequency agreed upon by the decoder 102 and the K encoders 101. At action 601, of the flowcharts of FIGS. 5A and 5B, the following inequality is evaluated:

$$2 \vert {W}_{E} \vert < \vert D \vert \vert C \vert \qquad ( 1 )$$

where |W_{E}| is the size of the EWB. Training may proceed according to one or another method, which are shown in FIG. 5A and FIG. 5B respectively, depending on whether the inequality is found to be true. The inequality of Equation 1 may be implemented in different forms according to different embodiments, as detailed further below. In some embodiments, each side of the inequality may be a communication cost function associated with the one or the other training methods.

When the inequality in Equation 1 is found to be true, action 602 of FIG. 5A may begin. This starts a new training epoch, which, in this example, spans forward propagation and back propagation processes for each of the K UEs 200. The training epoch begins for a first UE, i.e., k=1, at action 603. The respective UE 200 may obtain, at action 604, a set of latent representations, {C}ₖ, from the UE's encoder 101 through forward propagation of the set of samples of input data, {X}ₖ, of the UE's dataset 401 Dₖ, using EWB 301 W_{E}. The set of samples of input data may be known as the UE's batch of samples. At action 605, the UE 200 may send the set of latent representations and the corresponding set of true labels from the UE's dataset 401 to the decoder 102 in the server 402. The UE 200 may also send, at action 606, the EWB 301 over the edge 403 to the UE's corresponding DT 404, DTₖ. By sending the EWB 301 over the edge 403, back propagation actions that would typically be done at the encoder 101 may instead be done at the DT 400, which may, advantageously, reduce communication costs, as discussed below. Transmissions between the UE 200 and server 402 or the corresponding DT may be sent via the wireless channel 202. At action 607, the server 402 may obtain a set of predictions, {ŷ}ₖ, from the decoder 102 through forward propagation of the set of latent representations, using the DWB 302, W_{D}. Actions 604 to 607 may define one iteration of forward propagation for a UE 200.

Following the forward propagation, back propagation processes may start. At action 608, a set of errors may be calculated from the set of predictions and the set of true labels at the server 402. The set of errors may be calculated using an error metric function, F(y, ŷ). At action 609, a set of gradients of the errors with respect to the DWB, {∂e/∂W_{D}}ₖ, may be obtained through back propagation of the set of errors. The set of gradients of the errors with respect to the DWB may then be used to update the DWB 302. At action 610, a set of gradients of the errors with respect to the latent representations, {∂e/∂C}ₖ, may be obtained through back propagation of the set of gradients of the errors with respect to the DWB, using the set of latent representations. The set of gradients of the errors with respect to the latent representations may be sent, at action 611, to the UE's DT 404. At action 612, at the DT 404, a set of gradients of the errors with respect to the EWB, {∂e/∂W_{E}}ₖ, may be obtained through back propagation of the set of gradients of the errors with respect to the latent representations. The set of gradients of the errors with respect to the EWB may then be used to update the EWB 301. At action 613, the EWB 301, having been updated, may be sent from the DT 404 to the next UE among the K UEs 200 (i.e., the k+1 UE). The next UE may then, at action 614, update its encoder 101 with the received EWB 301. Actions 608 to 614 may define one iteration of back propagation for a UE 200.

At action 615, the index of the current UE may be compared against the total number of UEs. The index may be incremented by one (i.e., k=k+1), at action 616, if the UE index does not equal the total number of UEs (i.e., k≠K), such that the next UE (i.e., the k+1 UE) may complete an iteration of forward propagation (i.e., actions 604 to 607) and an iteration of back propagation (i.e., actions 608 to 614). If all K UEs have completed iterations of forward propagation and back propagation (i.e., k=K), a criteria for training convergence may be evaluated at action 617. If convergence has been achieved, training may be concluded, at action 618. If convergence has not been achieved, a new training epoch may begin, per action 602, and the next UE to complete iterations of forward propagation and back propagation may become the first UE, per action 603. The actions of FIG. 5A may repeat iteratively until convergence has been achieved.

If, at action 601, the inequality in Equation 1 is found to be false, the actions of FIG. 5B may begin. A new training epoch may begin, at action 602 and actions 603 to 605 may be completed, as described in relation to FIG. 5A, for the first UE 200. From here, actions 615 and 616 may be completed, as described in relation to FIG. 5A but such that actions 604 and 605 are repeated iteratively for each UE of all K UE 200. At action 619, the sets of latent representations sent to the decoder 102 in the server 402 from each UE 200 may be concatenated at the server 402 into one aggregate latent representation, C. Actions 620 to 623 may proceed akin to actions 607 to 610 as described previously in relation to FIG. 5A but with the aggregate latent representation instead of the set of latent representations for an individual UE 200. At action 624, the set of gradients of the errors with respect to the latent representations may be sent from the server to each UE 200 of all K UEs 200. Each UE 200 may then, at action 625, obtain a set of gradients of the errors with respect to the EWB through back propagation and update the EWB 301 of their respective encoder 101. At action 617, criteria for training convergence may be evaluated, as described previously in relation to FIG. 5A. If convergence has been achieved, training may be concluded, at action 618. If convergence has not been achieved, a new training epoch may begin, per action 602. The actions of FIG. 5B may repeat iteratively until convergence has been achieved.

With the methods of FIG. 5A and FIG. 5B, the communication costs for training may vary according to whether the inequality of Equation 1 was found to be true or false. When the inequality is found to be true (FIG. 5A), the communication cost for each training epoch may be the cost of sending the set of latent representations for each UE 200 to the server 402, plus the cost of sending the EWB 301 to the DT 404 for each UE of the K UEs 200, plus the cost of returning the updated EWB 301 to each next UE of K UEs 200: |D∥C|+2K∥W_{E}|. The communication cost associated with action 611 may not be appreciable in comparison to these other costs typically. When the inequality is found to be false (FIG. 5B), the communication cost for each training epoch may be the cost of sending the set of latent representations for each UE 200 to the server 402 plus the cost of returning the set of gradients of the errors with respect to the latent representations to each UE of K UEs 200: |D∥C|+K|D∥C|. The reduction in communication costs, S, for a training epoch between when the inequality is found to be true and when the inequality is found to be false may be:

$$S = \frac{2 K \vert {W}_{E} \vert + \vert D \vert \vert C \vert}{K \vert D \vert \vert C \vert + \vert D \vert \vert C \vert + 2 K \vert {W}_{E} \vert + \vert D \vert \vert C \vert} \qquad ( 2 )$$

Embodiments of the present disclosure may implement the inequality of Equation 1 in another form. For example, the inequality may be:

$$2 \vert {W}_{E} \vert \leq \vert D \vert \vert C \vert \qquad ( 3 )$$

such that when the two sides are equal, the split NN may train according to the method of FIG. 5A. As another example, the inequality may fully compare the communication costs of the methods of FIG. 5A and FIG. 5B:

$$2 K \vert {W}_{E} \vert + \vert D \vert \vert C \vert < K \vert D \vert \vert C \vert + \vert D \vert \vert C \vert \qquad ( 4 )$$

A person skilled in the art will appreciate that the inequality of Equation 4 behaves the same as the inequality of Equation 1. The inequality may further be arranged to compare the communication costs of the methods of FIG. 5A and FIG. 5B to a threshold value, t. The communication costs may be summarized in a communication cost parameter, CCP, such that the following inequality may be evaluated:

$$t < CCP = \frac{K \vert D \vert \vert C \vert + \vert D \vert \vert C \vert}{2 K \vert {W}_{E} \vert + \vert D \vert \vert C \vert} = \frac{( K + 1 ) \vert D \vert \vert C \vert}{2 K \vert {W}_{E} \vert + \vert D \vert \vert C \vert} \qquad ( 5 )$$

A person skilled in the art will appreciate that when t=1 (i.e., equals unity), the inequality behaves the same as the inequality of Equation 1. The threshold value may be a pre-set value or may be adjustable. Furthermore, the communication cost parameter may be defined, generally, as a ratio between the communication costs for training with the EWB 301 not being sent across the network edge 403, Costs_A, (e.g., following the method of FIG. 5B) and the communication costs for training with the EWB 301 being sent across the network edge 403, Costs_B, (e.g., following the method of FIG. 5A):

$$CCP = \frac{{Costs}_{A}}{{Costs}_{B}} \qquad ( 6 )$$

In some embodiments, Costs_A and Costs_B may be functions of the properties of the wireless channel and/or the required duration to complete the transmissions involved in training.

Embodiments of the present disclosure may be implemented for multiple UEs 200 or for only one UE 200 (i.e., K=1). In the case of one user, for actions 613 and 614 of FIG. 5A, the next UE (i.e., the k+1 UE) may be the lone UE, such that the updated EWB 301 are returned to the lone UE and the lone UE updates its own encoder 101. In embodiments with multiple UEs 200, the first UE to complete the actions of FIG. 5A or FIG. 5B may be determined before the training protocols are invoked. The first UE may, alternatively, be assigned at the time of the training protocols initiating. The first UE may be determined, for example, by a random selection process or in accordance with the quality of the wireless channels 202 between each UE 200 and the base station 201.

The secure location 404 may be implemented in different forms for different embodiments or may be absent entirely. When present, the secure location 404 may be any proxy location that serves as an intermediary between the server 402 and the corresponding UE 200. Such a proxy location will, generally, be closer than the UE 200 to the server 402, such that communications between the proxy location and the server 402 are less costly than communications between the UE 200 and the server 402. In some embodiments the secure location 404 may be a DT across the network edge 403, as described previously. In other embodiments, the secure location 404 may be at the base station 201 or may be at the server 402. In some embodiments, each UE 200 may have a corresponding secure location 404, while in other embodiments a plurality of UEs 200 may share one or more secure locations 404. In still further embodiments, the secure location 404 may be absent and, for the method of FIG. 5A, the EWB 301 may be sent directly to the server 402.

Embodiments of the present disclosure may be implemented in various communication networks. In addition to the wireless network disclosed in FIG. 4, the methods of FIG. 5A and FIG. 5B may be implemented, for example, in a datacenter, a core network, an access network, a Wi-Fi network, an optical communication network, or a satellite communication network. The communication network may employ wireless channels 202 for transmissions, as described previously, or may employ optical fiber channels, or wired connections, or a combination thereof. The transmission of latent representations, true labels, model weights, gradients of the errors, and other data may be done over any of these connections or channels. Each encoder 101 may be located in a network element other than a user equipment (i.e., an encoder network element), such as, for example, an internet-of-things device, or in a combination of different network elements. Similarly, the decoder 101 may be located at any decoder network element, which, for example, may be a server 402 at a base station 201, as described previously, a satellite, or another network element.

Embodiments of the present disclosure may be implemented for various NNs handling different input data and producing different predictions. Input data may, for example, include actions taken by a UE 200, the position and movement of a UE 200, UE 200 sensor data, utilization of a network channel, network channel bandwidth, transmission rates in the network, transmission delays, or analytics data. Predictions may, for example, be directed towards future network congestion, scheduling of network resources, or detection of network anomalies. Some embodiments may produce classifications from the input data instead of predictions. For example, the NN may be directed towards traffic classification.

The errors, belonging to a set or otherwise, between predictions from a split NN and true labels of a dataset may be calculated using various error metric functions. In some embodiments, these functions may, for example, include a mean squared error function, a mean absolute error function, or another loss function. Training, according to the methods of the present disclosure, may iterate through multiple epochs until the magnitude of the errors is reduced to a threshold value, or a convergence criterion. The predictions may be said to have converged to the true labels. In some other embodiments, convergence may be assessed according to a rate of change in the errors between training epochs. In other embodiments, convergence may be deemed established by completing a set number of training epochs. In other embodiments, convergence may be established by monitoring a validation error. A subset of the input dataset, which the NN may not train on, may be used for validation. Error in the validation subset may be calculated at the end of every epoch (validation error), in addition to the errors calculated from the training data (training error). Convergence may be deemed established when changes in the errors of the validation subset begin to diverge from the changes associated with the errors of the training data or when the errors of the validation subset begin to increase.

In some embodiments of the present disclosure, true labels may be sent to the decoder network element at the time of forward propagation during training, as described previously. In some embodiments, there may be a delay between when training initiates and when the true labels are sent. This may be the case where input data on particular actions is obtained before the effects of the actions can be observed and measured. In other embodiments, the decoder network element may obtain the true labels through data collection or analysis performed by the decoder network element or other network elements. In such embodiments, the encoder network element may not be involved in obtaining the true labels.

In some embodiments, when the inequality of Equation 1 or other inequality described herein is found to be false, some of the training actions of FIG. 5B may be completed in parallel for the K UEs 200. For example, actions 604 and 605 may be completed in parallel for each UE 200, instead of following actions 615 and 616.

Embodiments of the present disclosure may be implemented using electronics hardware, software, or a combination thereof. Some embodiments may be implemented by one or multiple computer processors executing program instructions stored in memory. Some embodiments may be implemented partially or fully in hardware, for example, using one or more field programmable gate arrays (FPGAs) or application specific integrated circuits (ASICs) to rapidly perform processing operations.

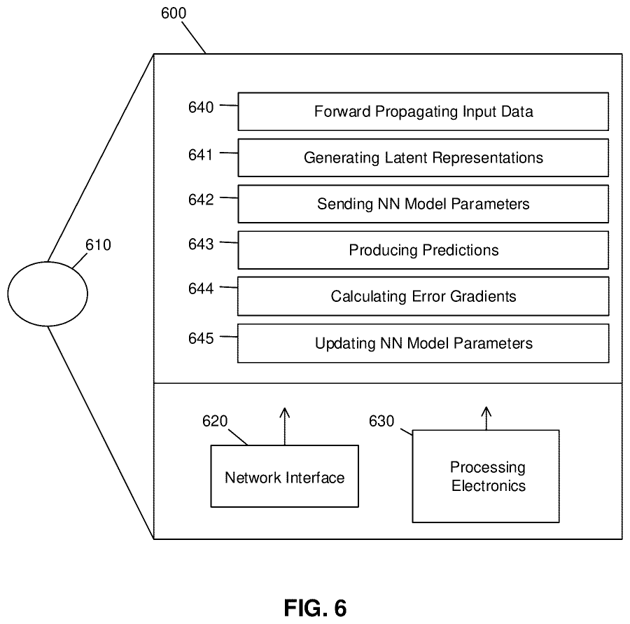

FIG. 6 shows an apparatus 600 for implementing, at least partly, methods for training a split NN according to embodiments of the present disclosure. The apparatus may be located at a network element 610 of a communication network. The apparatus may include a network interface 620 and processing electronics 630. The processing electronics 630 may include a computer processer executing program instructions stored in memory, or other electronics components such as digital circuitry, including, for example, FPGAs and ASICs. The network interface 620 may include an optical communication interface or radio communication interface, such as a transmitter and receiver. The apparatus 600 may include several functional components, each of which may be partially or fully implemented using the underlying network interface 620 and processing electronics 630. Examples of functional components may include modules for forward propagating 640 input data, generating 641 latent representations, sending 642 NN model parameters, producing 643 predictions, calculating 644 error gradients, and updating 645 NN model parameters.

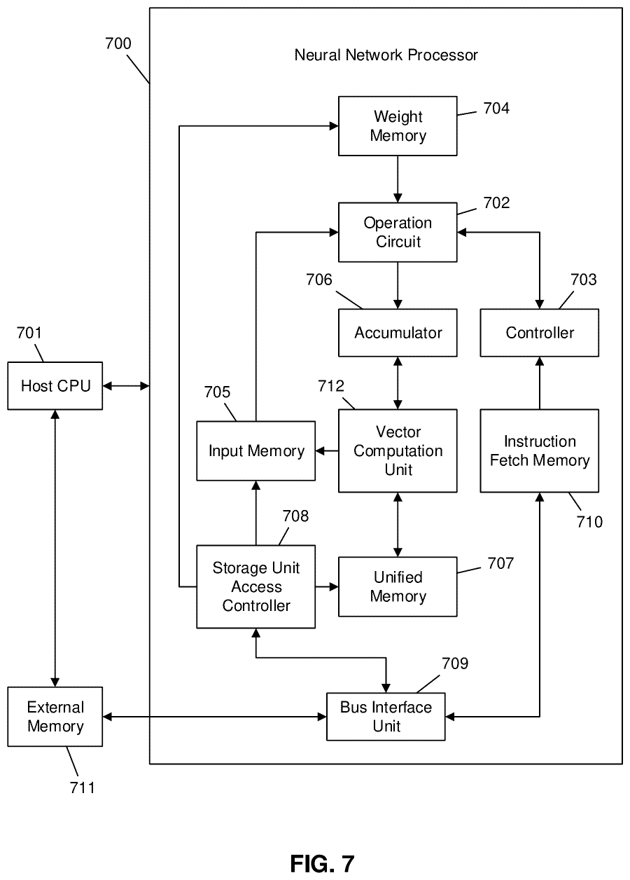

FIG. 7 shows a structural hardware diagram of a neural network processor (NPU) chip according to an embodiment of the present disclosure. The NPU chip includes an NPU 700 and may be provided in the processing electronics 630 of FIG. 6 to implement at least some of the functional components for training a split NN according to embodiments of the present disclosure.

The NPU 700 may be mounted, as a coprocessor, to a host CPU 701, and the host CPU 701 may allocate tasks to the NPU 700. A core part of the NPU 700 may be an operation circuit 702. A controller 703 may control the operation circuit 702 to extract matrix data from a memory and perform a multiplication operation.

In some implementations, the operation circuit 702 may internally include a plurality of processing units (process engine or PE). In some implementations, the operation circuit 702 may be a bi-dimensional systolic array. In addition, the operation circuit 702 may be a uni-dimensional systolic array or another electronic circuit that can implement a mathematical operation such as multiplication and addition. In some implementations, the operation circuit 702 may be a general matrix processor.

For example, it is assumed that there are an input matrix A, a weight matrix B, and an output matrix C. The operation circuit 702 may obtain, from a weight memory 704, data corresponding to the matrix B, and cache the data in each PE in the operation circuit 702. The operation circuit may obtain data of the matrix A from an input memory 705, and perform a matrix operation on the data of the matrix A and the data of the matrix B. An obtained partial or final matrix result may be stored in an accumulator (accumulator) 706.

A unified memory 707 may be configured to store input data and output data. Weight data may be directly moved to the weight memory 704 by using a storage unit access controller (for example, a direct memory access controller or DMAC) 708. The input data may also be moved to the unified memory 707 by using the DMAC 708.

A bus interface unit (BIU) 709 may be configured to enable an Advanced eXtensible Interface (AXI) bus to interact with the DMAC 708 and an instruction fetch memory (instruction fetch buffer) 710. The BIU 709 may be further configured to enable the instruction fetch memory 710 to obtain an instruction from an external memory 711, and may be further configured to enable the storage unit access controller 708 to obtain, from the external memory 711, source data of the input matrix A or the weight matrix B.

The DMAC 708 may be mainly configured to move input data from an external memory 711 DDR to the unified memory 707, or move the weight data to the weight memory 704, or move the input data to the input memory 705.

A vector computation unit 712 may include a plurality of operation processing units. If needed, the vector computation unit 712 may perform further processing, for example, vector multiplication, vector addition, an exponent operation, a logarithm operation, or magnitude comparison, on an output from the operation circuit. The vector computation unit 712 may be mainly used for non-convolutional/FC-layer network computation in a neural network, for example, pooling (pooling), batch normalization (batch normalization), or local response normalization (local response normalization).

In some implementations, the vector computation unit 712 may store, to the unified memory 707, a vector output through processing. For example, the vector computation unit 712 may apply a nonlinear function to an output of the operation circuit 702, for example, a vector of an accumulated value, to generate an activation value. In some implementations, the vector computation unit 712 may generate a normalized value, a combined value, or both a normalized value and a combined value. In some implementations, the vector output through processing may be used as activation input to the operation circuit 702, for example, to be used in a following layer of the NN.

The instruction fetch memory (instruction fetch buffer) 710 connected to the controller 703 may be configured to store an instruction used by the controller 703.

The unified memory 707, the input memory 705, the weight memory 704, and the instruction fetch memory 710 may all be on-chip memories. The external memory 711 may be independent from the hardware architecture of the NPU 700.

Operations at the layers of the NNs (e.g., the encoder and decoder layers) may be performed by the operation circuit 702 or the vector computation unit 712.

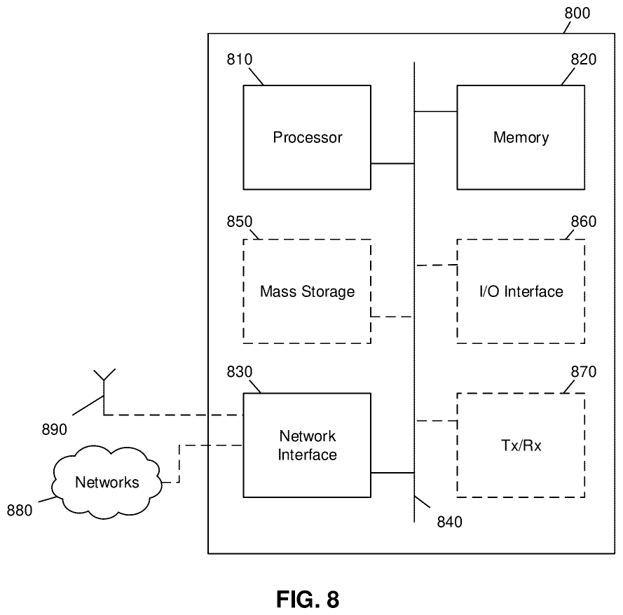

FIG. 8 is a schematic diagram of an electronic device 600 that may perform any or all of the operations of the above methods and features explicitly or implicitly described herein, according to different embodiments of the present disclosure. For example, a computer equipped with network functions may be configured as electronic device 800. The electronic device 800 may be used as part of one or more of: a controller, a server, a base station, a processing device, etc.

As shown, the device includes a processor 810, such as a Central Processing Unit (CPU) or specialized processors such as a Graphics Processing Unit (GPU) or an NPU or other such processor unit, memory 820, a network interface 830, and a bi-directional bus 840 to communicatively couple the components of electronic device 800. Electronic device 800 may also optionally include non-transitory mass storage 850, an I/O interface 860, and a transceiver 870. According to certain embodiments, any or all of the depicted elements may be utilized, or only a subset of the elements. Furthermore, the device 800 may contain multiple instances of certain elements, such as multiple processors, memories, or transceivers. In addition, elements of the hardware device may be directly coupled to other elements without the bi-directional bus. Additionally or alternatively to a processor 810 and memory 820, other electronics, such as integrated circuits, may be employed for performing the required logical operations.

The memory 820 may include any type of non-transitory memory such as static random access memory (SRAM), dynamic random access memory (DRAM), synchronous DRAM (SDRAM), read-only memory (ROM), any combination of such, or the like. Memory 820 may include more than one type of memory, such as ROM for use at boot-up, and DRAM for program and data storage for use while executing programs. The mass storage element 850 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 850 may have recorded thereon statements and instructions executable by the processor 810 for performing any of the aforementioned method operations described above. In some embodiments, mass storage 850 may be remote to the electronic device 800 and accessible through use of a network interface such as interface 830. In the embodiment of FIG. 8, mass storage 850 is distinct from memory 820 and may generally perform storage tasks compatible with higher latency but may generally provide lesser or no volatility. In some embodiments, mass storage 850 may be integrated with the memory 820.

Network interface 830 may include at least one of a wired network interface and a wireless network interface. The network interface 830 may include a wired network interface to connect to a communication network 880 and may also include a radio access network interface 890 for connecting to the communication network 880 or to other network elements over a radio link. The network interface 830 enables the electronic device 800 to communicate with remote entities such as those connected to the communication network 880.

The bi-directional bus 840 may be one or more of any type of several bus architectures, including a memory bus or memory controller, a peripheral bus, or a video bus.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein may be implemented as coded instructions in a computer program product. In other words, the computer program product may be a computer-readable medium upon which software code may be recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Embodiments of the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which may be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method, comprising:
determining a communication cost parameter (CCP) for training a neural network (NN), the NN having one or more NN encoders and an NN decoder, the one or more NN encoders making up an NN encoder series, each NN encoder having respective encoder model parameters, each NN encoder being deployed in a respective encoder network element of one or more encoder network elements, the NN decoder being deployed in a decoder network element, each encoder network element being coupled to the decoder network element across a respective first separation, each encoder network element being coupled to a respective proxy location of one or more proxy locations, each proxy location being coupled to the decoder network element over a respective second separation, and each second separation being shorter than the respective first separation; and
when the CCP is greater than a threshold value, performing a set of actions for each NN encoder over the NN encoder series, the set of actions comprising:
sending, by the respective encoder network element, the respective encoder model parameters to the respective proxy location.

2. The method of claim 1, further comprising:
when the CCP is greater than the threshold value, repeating the set of actions for each NN encoder over the NN encoder series one or more times.

3. The method of claim 1 further comprising:
when the CCP is equal to the threshold value, performing the set of actions for each NN encoder over the NN encoder series.

4. The method of claim 3, further comprising:
when the CCP is equal to the threshold value, repeating the set of actions for each NN encoder over the NN encoder series one or more times.

5. The method of claim 1, wherein:
each NN encoder is configured to process respective input data having respective true labels;
the NN decoder has decoder model parameters; and
the set of actions further comprises:
forward propagating, by the respective NN encoder and in accordance with the respective encoder model parameters, respective input data to obtain respective latent codes;
sending, by the respective encoder network element, the respective latent codes to the NN decoder; and
forward propagating, by the NN decoder and in accordance with the decoder model parameters, the respective latent codes to obtain respective prediction labels.

6. The method of claim 5, wherein the set of actions further comprises:
determining respective errors between the respective prediction labels and respective true labels;
back propagating the respective errors to obtain respective gradients of the respective errors with respect to the decoder model parameters;
back propagating the respective gradients of the respective errors with respect to the decoder model parameters to update the decoder model parameters;
back propagating the respective gradients of the respective errors with respect to the decoder model parameters to obtain respective gradients of the respective errors with respect to the respective latent codes;
sending, by the decoder network location, the respective gradients of the respective errors with respect to the respective latent codes to the respective proxy location;
back propagating, at the respective proxy location, the respective gradients of the respective errors with respect to the respective latent codes to update the respective encoder model parameters;
sending, by the respective proxy location, the respective encoder model parameters to a next encoder network element, the next encoder network element being one of the one or more encoder network elements and defined by the encoder series; and
updating, at the next encoder network element, next encoder model parameters, the next encoder model parameters being encoder model parameters corresponding to a next NN encoder, the next NN encoder being one of the one or more NN encoders and corresponding to the next encoder network element.

7. The method of claim 1, wherein:
the set of actions is a first set of actions;
each NN encoder is configured to process respective input data having respective true labels;
the NN decoder has decoder model parameters; and
the method further comprises:
when the CCP is less than the threshold value, performing a second set of actions, the second set of actions comprising:
forward propagating, by each NN encoder and in accordance with the respective encoder model parameters, respective input data to obtain respective latent codes;
sending, by each encoder network element, the respective latent codes to the NN decoder;
concatenating the latent codes to obtain an aggregate latent code;
forward propagating, by the NN decoder and in accordance with the decoder model parameters, the aggregate latent code to obtain a set of prediction labels;
determining a set of errors between the set of prediction labels and a set of true labels, the set of true labels comprising the true labels of the input data of each NN encoder;
back propagating the set of errors to obtain a set of gradients of the set of errors with respect to the decoder model parameters;
back propagating the set of gradients of the set of errors with respect to the decoder model parameters to update the decoder model parameters;
back propagating the set of gradients of the respective errors with respect to the decoder model parameters to obtain a set of gradients of the respective errors with respect to the aggregate latent code;
sending, by the decoder network element, the set of gradients of the errors with respect to the aggregate latent code to each encoder network element of the one or more encoder network elements; and
back propagating, at each encoder network element, the set of gradients of the set of errors with respect to the aggregate latent code to update the respective encoder model parameters of the respective NN encoder.

8. The method of claim 7, further comprising:
when the CCP is less than the threshold value, repeating the second set of actions one or more times.

9. The method of claim 6, wherein back propagating, at the respective proxy location, the respective gradients of the respective errors with respect to the respective latent codes to update the respective encoder model parameters includes calculating respective gradients of the respective errors with respect to the respective encoder model parameters.

10. The method of claim 7, wherein back propagating, at each encoder network element, the set of gradients of the set of errors with respect to the aggregate latent code to update the encoder model parameters of the respective NN encoder includes calculating a respective set of gradients of the set of errors with respect to the respective encoder model parameters.

11. A communication network, comprising:
one or more encoder network elements each having a neural network (NN) encoder, each NN encoder having encoder model parameters and being configured to generate one or more latent codes from input data in accordance with the respective encoder model parameters, each encoder network element being configured to:
obtain input data;
transmit latent codes; and
transmit, when a communication cost parameter (CCP) is greater than a threshold value, encoder model parameters;
one or more proxy locations each being coupled to one or more encoder network elements, each proxy location being configured to:
receive encoder model parameters from the respective one or more encoder network elements; and
a decoder network element having an NN decoder, the decoder network element being coupled to each encoder network element and each proxy location, the NN decoder having decoder model parameters and being configured to generate one or more prediction labels from latent codes in accordance with the decoder model parameters, the decoder network element configured to:
receive latent codes from each encoder network element.

12. The communication network of claim 11, wherein the decoder network element is further configured to:
obtain true labels corresponding to the input data of each encoder network element;
determine an error between each prediction label and the respective true label;
back propagate each error to obtain a gradient of the respective error with respect to the decoder model parameters;
back propagate each gradient of an error with respect to the decoder model parameters to update the decoder model parameters;
back propagate each gradient of an error with respect to the decoder model parameters to obtain a respective gradient of the error with respect to a respective latent code; and
transmit each gradient of an error with respect to a respective latent code.

13. The communication network of claim 12, wherein each proxy location is further configured to:
receive gradients of errors with respect to respective latent codes from the decoder network element;
back propagate each gradient of an error with respect to a respective latent code to obtain a respective gradient of the error with respect to respective encoder model parameters;
back propagate each gradient of an error with respect to respective encoder model parameters to update the respective encoder model parameters; and
transmit encoder model parameters.

14. The communication network of claim 13, wherein each encoder network element is further configured to:
receive encoder model parameters from the respective proxy location.

15. The communication network of claim 11, wherein each encoder network element is further configured to:
receive gradients of errors with respect to respective latent codes from the decoder network element;
back propagate each gradient of an error with respect to a respective latent code to obtain a respective gradient of the error with respect to respective encoder model parameters; and
back propagate each gradient of an error with respect to respective encoder model parameters to update the respective encoder model parameters.

16. The communication network of claim 11, wherein each encoder network element is further configured to:
transmit, when the CCP is equal to the threshold value, encoder model parameters.

17. The communication network of claim 11, wherein the CCP is defined by a ratio of a first communication cost to a second communication cost.

18. The communication network of claim 17, wherein the first communication cost depends from a product comprising a size of an input dataset and a size of one latent code, the input dataset comprising input data obtained by each encoder network element.

19. The communication network of claim 17, wherein the first communication cost is defined by a product comprising:
a size of an input dataset, the input dataset comprising input data obtained by each encoder network element;
a size of one latent code; and
a sum comprising 1 and a count of the one or more encoder network elements.

20. The communication network of claim 11, wherein:
each encoder network element is coupled to the decoder network element over a respective first separation;
each proxy location is coupled to the decoder network element over a respective second separation; and
each second separation is shorter than the respective first separation.
